(19) United States
(12) Patent Application Publication
(10) Pub. No.: US 2021/0292514 A1
(43) Pub. Date: Sep. 23, 2021

(54) THIOETHER SILANES, METHOD FOR THE PRODUCTION THEREOF, AND USE THEREOF

(71) Applicant: Evonik Operations GmbH, Essen (DE)

(72) Inventors: Alexander KÖPFER, Bernau im Schwarzwald (DE); Sebastian ROSENSTINGL, Loerrach (DE); Stefanie MAYER, Rheinfelden (DE); Caren RÖBEN, Essen (DE); Olga KUFELT, Hannover (DE); Hannes JÜRGENS, Bornheim (DE)

(73) Assignee: Evonik Operations GmbH, Essen (DE)

(21) Appl. No.: 17/263,707

(22) PCT Filed: Jul. 16, 2019
(86) PCT No.: PCT/EP2019/069055

§ 371 Date: Jan. 27, 2021

(30) Foreign Application Priority Data
Jul. 30, 2018 (DE) 10 2018 212 672.0
Aug. 23, 2018 (DE) 10 2018 214 229.7

(51) Int. Cl. C08K 5/548; C07F 7/18; C08L 9/06

(52) U.S. Cl. CPC C08K 5/548; C07F 7/1892; B60C 1/0016; C08L 9/06; C07F 7/1804

(57) ABSTRACT

The invention relates to thioether silanes of the formula I

(R¹)ₓ(R²)₃₋ₓSi—R³—S—C(CH₂R⁴)_{y}(R⁵)_{3-y} (I),

which are prepared by reacting the silane of the formula II

(R¹)ₓ(R²)₃₋ₓSi—R³—SH (II)

with an alkene of the formula III

R⁴—HC═C(CH₂R)_{y-1}(R⁵)_{3-y} (III).

The thioether silanes can be used for production of rubber mixtures.

The invention relates to thioether silanes, to processes for preparation thereof and to the use thereof.

CAS 93575-00-9 discloses a compound of the formula

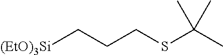

In addition, WO 2005059022 A1 and WO 2007039416 A1 disclose silanes of the formula

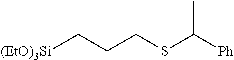

and the use thereof in rubber mixtures.

Chem. Commun. 2011, 47, 11113-11115 discloses a silane of the formula

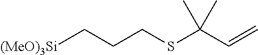

and DE 2340886 A1 a silane of the formula

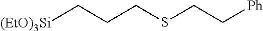

In addition, JP 2008310044 A discloses silanes of the formula

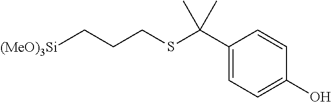

and the use thereof in microlenses.

Disadvantages of the known silanes are inadequate abrasion resistance and low dynamic stiffness in rubber mixtures.

The problem addressed by the present invention is that of providing thioether silanes that have advantages in abrasion resistance and dynamic stiffness over the silanes known from the prior art in rubber mixtures.

The invention provides a thioether silane of the formula I

(R¹)ₓ(R²)₃₋ₓSi—R³—S—C(CH₂R)_{y}(R⁵)_{3-y} (I)

where R¹ is the same or different and is C1-C10-alkoxy groups, preferably ethoxy, phenoxy groups, C4-C10-cycloalkoxy groups or alkyl polyether groups —O—(R⁶—O)ᵣR⁷ where R⁶ is the same or different and is a branched or unbranched, saturated or unsaturated, aliphatic, aromatic or mixed aliphatic/aromatic divalent C1-C30 hydrocarbon group, r is an integer from 1 to 30 and R⁷ is an unsubstituted or substituted, branched or unbranched, monovalent alkyl, alkenyl, aryl or aralkyl group,

R² is the same or different and is C6-C20-aryl groups, C1-C10-alkyl groups, C2-C20-alkenyl groups, C7-C20-aralkyl groups or halogen,

R³ is a branched or unbranched, saturated or unsaturated, aliphatic, aromatic or mixed aliphatic/aromatic divalent C1-C30 hydrocarbon group,

R⁴ is the same or different and is H, branched or unbranched, saturated or unsaturated, aliphatic C1-C30 hydrocarbon groups,

R⁵ is the same or different and is unsubstituted C6-C20-aryl groups, alkyl-substituted C6-C20-aryl groups or —C≡C—R⁸ groups, preferably unsubstituted C6-C20-aryl groups, more preferably phenyl groups, where R⁸ is H, an unsubstituted or substituted, branched or unbranched monovalent alkyl group or a C6-C20-aryl group, and x=1, 2 or 3, preferably 3, y=1 or 2, preferably 2.

Thioether silanes may be mixtures of thioether silanes of the formula I.

The inventive thioether silane of the formula I may contain oligomers, preferably dimers, that form through hydrolysis and condensation of the alkoxysilane functions of the thioether silanes of the formula I.

The inventive thioether silane of the formula I may contain isomers that form through a different regioselectivity in the preparation of the thioether silanes of the formula I.

The thioether silanes of the formula I may have been applied to a support, for example wax, polymer or carbon black. The thioether silanes of the formula I may have been applied to a silica, in which case the binding may be physical or chemical.

R³ may preferably be —CH₂—, —CH₂CH₂—, —CH₂CH₂CH₂—, —CH₂CH₂CH₂CH₂—, —CH(CH₃)—, —CH₂CH(CH₃)—, —CH(CH₃)CH₂—, —C(CH₃)₂—, —CH(C₂H₅)—, —CH₂CH₂CH(CH₃)—, —CH(CH₃)CH₂CH₂—, —CH₂CH(CH₃)CH₂—, —CH₂CH₂CH₂CH₂CH₂—, —CH₂CH₂CH₂CH₂CH₂CH₂—, —CH₂CH₂CH₂CH₂CH₂CH₂CH₂—, —CH₂CH₂CH₂CH₂CH₂CH₂CH₂CH₂—, —CH₂CH₂CH₂CH₂CH₂CH₂CH₂CH₂CH₂—, —CH₂CH₂CH₂CH₂CH₂CH₂CH₂CH₂CH₂CH₂—, —CH₂CH₂CH₂CH₂CH₂CH₂CH₂CH₂CH₂CH₂CH₂CH₂—, —CH₂CH₂CH₂CH₂CH₂CH₂CH₂CH₂CH₂CH₂CH₂CH₂CH₂CH₂—, —CH₂CH₂CH₂CH₂CH₂CH₂CH₂CH₂CH₂CH₂CH₂CH₂CH₂CH₂CH₂CH₂—, —CH₂CH₂CH₂CH₂CH₂CH₂CH₂CH₂CH₂CH₂CH₂CH₂CH₂CH₂CH₂CH₂CH₂CH₂— or

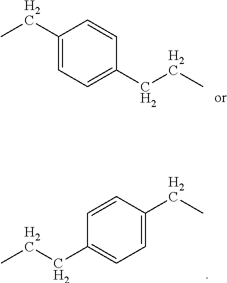

R¹ may preferably be methoxy or ethoxy, more preferably ethoxy.

R⁴ may preferably be H, methyl or ethyl, more preferably H.

R⁵ may preferably be phenyl, naphthyl or tolyl, more preferably phenyl.

Thioether silanes of the formula I may preferably be compounds with R¹ ethoxy, R⁴ H, and R⁵ phenyl or tolyl.

Thioether silane of the formula I may more preferably be compounds with R¹ ethoxy, x=3, R³ CH₂CH₂CH₂, R⁴ H, and R⁵ phenyl.

Thioether silanes of the formula I may preferably be:

(EtO)₃Si—CH₂—S—C(CH₃)₂(phenyl),

(EtO)₃Si—CH₂CH₂—S—C(CH₃)₂(phenyl),

(EtO)₃Si—CH₂CH₂CH₂—S—C(CH₃)₂(phenyl),

(EtO)3Si—CH₂—S—C(CH₃)(phenyl)₂,

(EtO)₃Si—CH₂CH₂—S—C(CH₃)(phenyl)₂,

(EtO)₃Si—CH₂CH₂CH₂—S—C(CH₃)(phenyl)₂,

(EtO)₃Si—CH₂—S—C(CH₃)₂(naphthyl),

(EtO)₃Si—CH₂CH₂—S—C(CH₃)₂(naphthyl),

(EtO)₃Si—CH₂CH₂CH₂—S—C(CH₃)₂(naphthyl),

(EtO)₃Si—CH₂—S—C(CH₃)(naphthyl)₂,

(EtO)₃Si—CH₂CH₂—S—C(CH₃)(naphthyl)₂,

(EtO)₃Si—CH₂CH₂CH₂≥S≥C(CH₃)(naphthyl)₂,

(EtO)₃Si—CH₂—S—C(CH₃)₂(tolyl),

(EtO)₃Si—CH₂CH₂—S—C(CH₃)₂(tolyl),

(EtO)₃Si—CH₂CH₂CH₂—S—C(CH₃)₂(tolyl),

(EtO)₃Si—CH₂—S—C(CH₃)(tolyl)₂,

(EtO)₃Si—CH₂CH₂—S—C(CH₃)(tolyl)₂,

(EtO)₃Si—CH₂CH₂CH₂—S—CH₃)(tolyl)₂,

(H₂₇C₁₃—(O—C₂H₄)₅—O)(EtO)₂Si—CH₂—S—C(CH₃)₂(phenyl),

(H₂₇C₁₃—(O—C₂H₄)₅—O)(EtO)₂Si—CH₂CH₂—S—C(CH₃)₂(phenyl),

(H₂₇C₁₃—(O—C₂H₄)₅—O)(EtO)₂Si—CH₂CH₂CH₂−S—C(CH₃)₂(phenyl),

(H₂₇C₁₃—(O—C₂H₄)₅—O)(EtO)₂Si—CH₂—S—C(CH₃)(phenyl)₂,

(H₂₇C₁₃—(O—C₂H₄)₅—O)(EtO)₂Si—CH₂CH₂—S—C(CH₃)(phenyl)₂,

(H₂₇C₁₃—(O—C₂H₄)₅—O)(EtO)₂Si—CH₂CH₂CH₂—S—C(CH₃)(phenyl)₂,

(H₂₇C₁₃—(O—C₂H₄)₅—O)(EtO)₂Si—CH₂—S—C(CH₃)₂(naphthyl),

(H₂₇C₁₃—(O—C₂H₄)₅—O)(EtO)₂Si—CH₂CH₂—S—C(CH₃)₂(naphthyl),

(H₂₇C₁₃—(O—C₂H₄)₅—O)(EtO)₂Si—CH₂CH₂CH₂—S—C(CH₃)₂(naphthyl),

(H₂₇C₁₃—(O—C₂H₄)₅—O)(EtO)₂Si—CH₂—S—C(CH₃)(naphthyl)₂,

(H₂₇C₁₃—(O—C₂H₄)₅—O)(EtO)₂Si—CH₂CH₂—S—C(CH₃)(naphthyl)₂,

(H₂₇C₁₃—(O—C₂H₄)₅—O)(EtO)₂Si—CH₂CH₂CH₂—S—C(CH₃)(naphthyl)₂,

(H₂₇C₁₃—(O—C₂H₄)₅—O)(EtO)₂Si—CH₂—S—C(CH₃)₂(tolyl),

(H₂₇C₁₃—(O—C₂H₄)₅—O)(EtO)₂Si—CH₂CH₂—S—C(CH₃)₂(tolyl),

(H₂₇C₁₃—(O—C₂H₄)₅—O)(EtO)₂Si—CH₂CH₂CH₂—S—C(CH₃)₂(tolyl),

(H₂₇C₁₃—(O—C₂H₄)₅—O)(EtO)₂Si—CH₂—S—C(CH₃)(tolyl)₂,

(H₂₇C₁₃—(O—C₂H₄)₅—O)(EtO)₂Si—CH₂CH₂—S—C(CH₃)(tolyl)₂,

(H₂₇C₁₃—(O—C₂H₄)₅—O)(EtO)₂Si—CH₂CH₂CH₂—S—C(CH₃)(tolyl)₂,

(MeO)₃Si—CH₂—S—C(CH₃)₂(phenyl),

(MeO)₃Si—CH₂CH₂—S—C(CH₃)₂(phenyl),

(MeO)₃Si—CH₂CH₂CH₂—S—C(CH₃)₂(phenyl),

(MeO)3Si—CH₂—S—C(CH₃)(phenyl)₂,

(MeO)₃Si—CH₂CH₂—S—C(CH₃)(phenyl)₂,

(MeO)₃Si—CH₂CH₂CH₂—S—C(CH₃)(phenyl)₂,

(MeO)₃Si—CH₂—S—C(CH₃)₂(naphthyl),

(MeO)₃Si—CH₂CH₂—S—C(CH₃)₂(naphthyl),

(MeO)₃Si—CH₂CH₂CH₂—S—C(CH₃)₂(naphthyl),

(MeO)₃Si—CH₂—S—C(CH₃)(naphthyl)₂,

(MeO)₃Si—CH₂CH₂—S—C(CH₃)(naphthyl)₂,

(MeO)₃Si—CH₂CH₂CH₂—S—C(CH₃)(naphthyl)₂,

(MeO)₃Si—CH₂—S—C(CH₃)₂(tolyl),

(MeO)₃Si—CH₂CH₂—S—C(CH₃)₂(tolyl),

(MeO)₃Si—CH₂CH₂CH₂—S—C(CH₃)₂(tolyl),

(MeO)₃Si—CH₂—S—C(CH₃)(tolyl)₂,

(MeO)₃Si—CH₂CH₂—S—C(CH₃)(tolyl)₂,

(MeO)₃Si—CH₂CH₂CH₂—S—C(CH₃)(tolyl)₂,

(EtO)₃Si—CH₂—S—C(CH₃)₂C≡CH,

(EtO)₃Si—CH₂CH₂—S—C(CH₃)₂C≡CH,

(EtO)₃Si—CH₂CH₂CH₂—S—C(CH₃)₂C≡CH,

(EtO)₃Si—CH₂—S—C(CH₃)₂C≡C—CH₂CH₃,

(EtO)₃Si—CH₂CH₂—S—C(CH₃)₂C≡C—CH₂CH₃,

(EtO)₃Si—CH₂CH₂CH₂—S—C(CH₃)₂C≡C—CH₂CH₃,

(EtO)₃Si—CH₂—S—C(CH₃)₂C≡C—CH₃,

(EtO)₃Si—CH₂CH₂—S—C(CH₃)₂C≡C—CH₃,

(EtO)₃Si—CH₂CH₂CH₂—S—C(CH₃)₂C≡C—CH₃,

(EtO)₃Si—CH₂—S—C(CH₃)₂C≡C-Ph,

(EtO)₃Si—CH₂CH₂—S—C(CH₃)₂C≡C-Ph,

(EtO)₃Si—CH₂CH₂CH₂—S—C(CH₃)₂C≡C-Ph,

(MeO)₃Si—CH₂—S—C(CH₃)₂C≡CH,

(MeO)₃Si—CH₂CH₂—S—C(CH₃)₂C≡CH,

(MeO)₃Si—CH₂CH₂CH₂—S—C(CH₃)₂C≡CH,

(MeO)₃Si—CH₂—S—C(CH₃)₂C≡C—CH₂CH₃,

(MeO)₃Si—CH₂CH₂—S—C(CH₃)₂C≡C—CH₂CH₃,

(MeO)₃Si—CH₂CH₂CH₂—S—C(CH₃)₂C≡C—CH₂CH₃,

(MeO)₃Si—CH₂—S—C(CH₃)₂C≡C—CH₃,

(MeO)₃Si—CH₂CH₂—S—C(CH₃)₂C≡C—CH₃,

(MeO)₃Si—CH₂CH₂CH₂—S—C(CH₃)₂C≡C—CH₃,

(MeO)₃Si—CH₂—S—C(CH₃)₂C≡C-Ph,

(MeO)₃Si—CH₂CH₂—S—C(CH₃)₂C≡C-Ph,

(MeO)₃Si—CH₂CH₂CH₂—S—C(CH₃)₂C≡C-Ph.

Especially preferred compounds are those of the formula (EtO)₃Si—CH₂CH₂CH₂—S—C(CH₃)₂(phenyl) and (EtO)₃Si—CH₂CH₂CH₂—S—C(CH₃)(phenyl)₂.

The invention further provides a process for preparing the inventive thioether silanes of the formula I

(R¹)ₓ(R²)₃₋ₓSi—R³—S—C(CH₂R⁴)_{y}(R⁵)_{3-y} (I)

where R¹, R², R³, R⁴, R⁵, x and y have the definition given above, which is characterized in that a silane of the formula II

(R¹)ₓ(R²)₃₋ₓSi—R³—SH (II)

is reacted with an alkene of the formula III

R⁴—HC═C(CH₂R⁴)_{y-1}(R⁵)_{3-y} (III).

Silanes of the formula II may preferably be:

(C₂H₅O)₃Si—CH₂—SH,

(C₂H₅O)₃Si—CH₂CH₂—SH,

(C₂H₅O)₃Si—CH₂CH₂CH₂—SH,

(H₂₇C₁₃—(O—C₂H₄)₅—O)(C₂H₅O)₂Si—CH₂—SH,

(H₂₇C₁₃—(O—C₂H₄)₅—O)(C₂H₅O)₂Si—CH₂CH₂—SH,

(H₂₇C₁₃—(O—C₂H₄)₅-O)(C₂H₅O)₂Si—CH₂CH₂CH₂—SH,

(CH₃O)₃Si—CH₂—SH,

(CH₃O)₃Si—CH₂CH₂—SH or

(CH₃O)₃Si—CH₂CH₂CH₂—SH.

Compounds of the formula III may preferably be:

H₂C═C(Me)(phenyl),

H₂C═C(Me)(naphthyl),

H₂C═C(Me)(tolyl),

H₂C═C(phenyl)(phenyl),

H₂C═C(naphthyl)(naphthyl),

H₂C═C(tolyl)(tolyl),

H₂C═C(Me)C≡CH,

H₂C═C(Me)C≡C≡CH₃,

H₂C═C(Me)C≡C≡CH₂CH₃ or

H₂C═C(Me)C≡C(phenyl).

The reaction can be conducted with exclusion of air.

The reaction may be carried out under a protective gas atmosphere, for example under argon or nitrogen, preferably under nitrogen.

The process according to the invention can be conducted at standard pressure, elevated pressure or reduced pressure. Preferably, the process according to the invention can be conducted at standard pressure.

Elevated pressure may be a pressure of 1.1 bar to 100 bar, preferably of 1.1 bar to 50 bar, more preferably of 1.1 bar to 20 bar and very preferably of 1.1 to 10 bar.

Reduced pressure may be a pressure of 1 mbar to 1000 mbar, preferably 1 mbar to 500 mbar, more preferably 1 mbar to 250 mbar, very preferably 1 mbar to 100 mbar.

The process according to the invention can be conducted between 20° C. and 180° C., preferably between 60° C. and 140° C., more preferably between 70° C. and 110° C.

The reaction can be effected in a solvent, for example methanol, ethanol, propanol, butanol, cyclohexanol, N,N-dimethylformamide, dimethyl sulfoxide, pentane, hexane, cyclohexane, heptane, octane, decane, toluene, xylene, acetone, acetonitrile, diethyl ether, methyl tert-butyl ether, methyl ethyl ketone, tetrahydrofuran, dioxane, pyridine or ethyl acetate.

The reaction can preferably be conducted without a solvent.

The reaction may be conducted in a catalysed manner. Catalysts used may be BF₃, SO₃, SnCl₄, TiCl₄, SiCl₄, ZnCl₂, FeCl₃ or AlCl₃.

It is possible with preference to use FeCl₃, AlCl₃ or ZnCl₂.

It is possible with particular preference to use AlCl₃.

The co-reactants may all be initially charged together or metered into one another. Preferably, the compound of the formula III may be added to the silane of the formula II.

The process according to the invention can give rise to by-products, for example dimers of the thioether silanes of the formula I, dimers of the alkenes of the formula III and reaction product of the silane of the formula II with the R¹ substituent to form a thioether.

The thioether silanes of the formula I may be used as adhesion promoters between inorganic materials, for example glass beads, glass fragments, glass surfaces, glass fibres, or oxidic fillers, preferably silicas such as precipitated silicas and formed silicas, and organic polymers, for example thermosets, thermoplastics or elastomers, or as crosslinking agents and surface modifiers for oxidic surfaces.

The thioether silanes of the formula I may be used as coupling reagents in filled rubber mixtures, examples being tyre treads, industrial rubber articles or footwear soles.

The invention further provides rubber mixtures which are characterized in that they comprise at least one rubber and at least one thioether silane of the formula I.

The rubber mixture according to the invention may comprise a mercaptosilane. The mercaptosilane may be mercaptopropyltriethoxysilane, for example VP Si 263 from Evonik Resource Efficiency GmbH, blocked mercaptosilane, preferably 3-octanoylthio-1-propyltriethoxysilane, for example NXT™ from Momentive Performance Materials Inc., or transesterified mercaptopropyltriethoxysilane, preferably 4-((3,6,9,12,15-pentaoxaoctacosyl)oxy)-4-ethoxy-5,8,11,14,17,20-hexaoxa-4-silatritriacontane-1-thiol, for example Si 363™ from Evonik Resource Efficiency GmbH.

The rubber mixture may comprise at least one filler.

Fillers usable for the rubber mixtures according to the invention include the following fillers:
Carbon blacks: The carbon blacks to be used here may be produced by the lamp black process, furnace black process, gas black process or thermal black process. The carbon blacks may have a BET surface area of 20 to 200 m²/g. The carbon blacks may optionally also be doped, for example with Si.
Amorphous silicas, preferably precipitated silicas or formed silicas. The amorphous silicas may have a specific surface area of 5 to 1000 m²/g, preferably 20 to 400 m²/g (BET surface area) and a primary particle size of 10 to 400 nm. The silicas may optionally also be in the form of mixed oxides with other metal oxides, such as oxides of Al, Mg, Ca, Ba, Zn and titanium.
Synthetic silicates, such as aluminium silicate or alkaline earth metal silicates, for example magnesium silicate or calcium silicate. The synthetic silicates having BET surface areas of 20 to 400 m²/g and primary particle diameters of 10 to 400 nm.
Synthetic or natural aluminium oxides and hydroxides.
Natural silicates, such as kaolin and other naturally occurring silicas.
Glass fibres and glass-fibre products (mats, strands) or glass microbeads.

It is possible with preference to use amorphous silicas, more preferably precipitated silicas or silicates, especially preferably precipitated silicas having a BET surface area of 20 to 400 m²/g in amounts of 5 to 180 parts by weight in each case based on 100 parts of rubber.

The fillers mentioned may be used alone or in a mixture. In a particularly preferred embodiment of the process, it is possible to use 10 to 180 parts by weight of fillers, preferably precipitated silica, optionally together with 0 to 100 parts by weight of carbon black, and 0.1 to 20 parts by weight of thioether silane of the general formula I, based in each case on 100 parts by weight of rubber, to produce the mixtures.

Synthetic rubbers as well as natural rubber are suitable for producing the rubber mixtures according to the invention. Preferred synthetic rubbers are described for example in W. Hofmann, Kautschuktechnologie [Rubber Technology], Genter Verlag, Stuttgart 1980. These include
polybutadiene (BR),
polyisoprene (IR),
styrene/butadiene copolymers, for example emulsion SBR (E-SBR) or solution SBR (S-SBR), preferably having a styrene content of 1% to 60% by weight, more preferably 2% to 50% by weight, based on the overall polymer,
chloroprene
(CR),
isobutylene/isoprene copolymers (IIR),
butadiene/acrylonitrile copolymers, preferably having an acrylonitrile content of 5% to 60% by weight, preferably 10% to 50% by weight, based on the overall polymer (NBR),
partly hydrogenated or fully hydrogenated NBR rubber (HNBR),
ethylene/propylene/diene copolymers (EPDM) or
abovementioned rubbers additionally having functional groups, for example carboxyl, silanol or epoxy groups, for example epoxidized NR, carboxyl-functionalized NBR or silanol-functionalized (—SiOH) or siloxy-functionalized (—Si—OR), amino-, epoxy-, mercapto-, hydroxyl-functionalized SBR,
   and mixtures of these rubbers. Of particular interest for the production of automobile tyre treads are anionically polymerized S-SBR rubbers (solution SBR) having a glass transition temperature above −50° C. and mixtures thereof with diene rubbers.

The rubber used may more preferably be NR or functionalized or unfunctionalized S-SBR/BR.

The rubber mixtures according to the invention may comprise further rubber auxiliaries, such as reaction accelerators, ageing stabilizers, heat stabilizers, light stabilizers, antiozonants, processing aids, plasticizers, resins, tackifiers, blowing agents, dyes, pigments, waxes, extenders, organic acids, retarders, metal oxides, and activators such as diphenylguanidine, triethanolamine, polyethylene glycol, alkoxy-terminated polyethylene glycol alkyl-O—(CH₂—CH₂—O)_{yI}—H with y^{I}=2-25, preferably y^{I}=2-15, more preferably y^{I}=3-10, most preferably y^{I}=3-6, or hexanetriol, that are familiar to the rubber industry.

The rubber auxiliaries may be used in familiar amounts determined inter alia by factors including the intended use. Customary amounts may, for example, be amounts of 0.1% to 50% by weight based on rubber. Crosslinkers used may be peroxides, sulfur or sulfur donor substances. The rubber mixtures according to the invention may moreover comprise vulcanization accelerators. Examples of suitable vulcanization accelerators may be mercaptobenzothiazoles, sulfenamides, thiurams, dithiocarbamates, thioureas and thiocarbonates. The vulcanization accelerators and sulfur may be used in amounts of 0.1% to 10% by weight, preferably 0.1% to 5% by weight, based on 100 parts by weight of rubber.

The rubber mixtures according to the invention can be vulcanized at temperatures of 100° C. to 200° C., preferably 120° C. to 180° C., optionally at a pressure of 10 to 200 bar. The blending of the rubbers with the filler, any rubber auxiliaries and the thioether silanes can be conducted in known mixing units, such as rolls, internal mixers and mixing extruders.

The rubber mixtures according to the invention can be used for production of moulded articles, for example for the production of tyres, especially pneumatic tyres or tyre treads, cable sheaths, hoses, drive belts, conveyor belts, roll coverings, footwear soles, gasket rings and damping elements.

Advantages of the inventive thioether silanes of the formula I are improved abrasion resistance, and elevated dynamic stiffness in rubber mixtures.

### EXAMPLES

Determinations of purity were made by gas chromatography or NMR.

Gas chromatography: temperature programme: 70° C.-5 min-20° C./min-260° C.-15 min; column: Agilent HP5, length: 30 m-diameter: 230 μm-film thickness: 0.25 μm; detector: TCD. NMR spectra were recorded on a 400 MHz NMR instrument from BRUKER. The spectra were each calibrated to the signal of tetramethylsilane at 0.00 ppm for 1 H, 13C and 29Si spectra. In determinations of purity, tetramethylbenzene or dimethyl sulfone was used as internal standard.

### Comparative Example 1: (3-(tert-butylthio)propyl)triethoxysilane

To an initial charge of tert-butylthiol (119 g; 1.10 eq) was added dropwise sodium ethoxide (w=21%; 408 g; 1.05 eq). The mixture was stirred at 60° C. for about 1 h. Subsequently, CPTEO (289 g; 1.00 eq) was added dropwise at 60° C. Then the reaction mixture was refluxed for 5 h and then excess low boilers and solvent were removed by distillation at standard pressure. The distilled suspension was filtered and the crude product (filtrate) was distilled overhead by means of vacuum distillation (boiling point 90-95° C. and 0.6 mbar). (3-(tert-Butylthio)propyl)triethoxysilane (72% yield, purity: 99.6 a% determined by GC) was obtained as a clear colourless oil.

### Comparative Example 2: triethoxy(3-((1-phenylethyl)thio)propyl)silane

Under a protective gas atmosphere, ethanol (260 g; 11.9 eq) and elemental sodium (11.5 g; 1.00 eq) were used to prepare ethanolic sodium ethoxide solution. Thereafter, 3-mercaptopropyltriethoxysilane was added dropwise. On completion of addition, stirring was continued for 30 min. The reaction solution was heated to 60° C. by means of an oil bath, and 1-bromoethylbenzene was added dropwise within 20 min. The reaction mixture was stirred at 60° C. for a further 11 h. After the reaction had ended, the suspension was filtered and freed of low boilers by distillation. Triethoxy(3-((1-phenylethyl)thio)propyl)silane (93% yield, purity: >95% (NMR)) was obtained as a clear yellow oil.

### Example 1: (3-((1,1-Diphenylethyl)thio)propyl)triethoxysilane

An initial charge of 3-mercaptopropyltriethoxysilane (327 g; 1.0 eq), 1,1-diphenylethylene (247 g; 1.0 eq) and aluminium chloride (10.1 g; 2.0% by weight) at room temperature was stirred and heated to 80° C. by means of an oil bath. The mixture was stirred at this temperature for a further 33 hours and then cooled down to room temperature. Finally, the low boilers were removed by means of distillation.

(3-((1,1-Diphenylethyl)thio)propyl)triethoxysilane (yield: 63%, purity: 61.8% by weight (from combination of 13C and 29Si NMR with dimethyl sulfone as internal standard)) was obtained as a pale yellowish liquid.

Secondary components were 1,3-bis(3-((1,1-diphenylethyl)thio)propyl)-1,1,3,3-tetraethoxydisiloxane (28.2% by weight), triethoxy(3-(ethylthio)propyl)silane (4.6% by weight), 3-(triethoxysilyl)propanethiol (0.3% by weight), diphenylethylene (5.1% by weight).

### Example 2: triethoxy(3-((2-phenylpropan-2-yl)thio)propyl)silane

An initial charge of 3-mercaptopropyltriethoxysilane (403 g; 1.0 eq), α-methylstyrene (200 g; 1.0 eq) and aluminium chloride (8.12 g; 2.0 mol %) at room temperature was stirred and heated to 100° C. by means of an oil bath. The mixture was stirred at this temperature for 16 hours and then left to cool down to room temperature. Then it was filtered and the low boilers were removed by means of distillation.

Triethoxy(3-((2-phenylpropan-2-yl)thio)propyl)silane (yield: 99%, purity: 80.1% by weight (from combination of 13C and 29Si NMR with dimethyl sulfone as internal standard)) was obtained as a colourless liquid.

Secondary components were 1,1,3,3-tetraethoxy-1,3-bis(3-((2-phenylpropan-2-yl)thio)propyl)disiloxane (11.6% by weight), triethoxy(3-(ethytthio)propyl)silane (5.1% by weight), 3-(triethoxysityl)propanethiot (0.9% by weight), α-methylstyrene (0.7% by weight), α-methylstyrene dimer (1.6% by weight).

### Example 3: 7,7-Diethoxy-2-methyl-2-phenyl-8,11,14,17,20,23-hexaoxa-3-thia-7-silahexatriacontane

Triethoxy(3-((2-phenylpropan-2-yl)thio)propyl)silane (from Example 2, 106.2 g; 1.0 eq), 3,6,9,12,15-pentaoxaoctacosan-1-ol (125.3 g; 1.0 eq) and titanium tetrabutoxide (53 μl; 0.05% by weight/triethoxy(3-((2-phenylpropan-2-yl)thio)propyl)silane) added. The mixture was heated to 140° C., the ethanol formed was distilled off and, after 1 h, a pressure of 400-600 mbar was established. After 1 h, the pressure was reduced to 16-200 mbar and the mixture was stirred for 4 h. Subsequently, the reaction mixture was allowed to cool to room temperature and the reaction product is filtered. 7,7-Diethoxy-2-methyl-2-phenyl-8,11,14,17,20,23-hexaoxa-3-thia-7-silahexatriacontane (yield: 99%, transesterification level 33% polyether alcohol/Si) was obtained as a viscous liquid.

The determination of purity and the analysis of the esterification level were made by means of ¹³C NMR. In the NMR, the shift of the CH₂ group at 61.8 ppm (adjacent to the OH group) compared to the bound variant at 61.9-62.1 ppm is characteristic, and it is possible to make a comparison against remaining ethoxy groups on the silicon atom at 58.0-58.5 ppm.

### Examples 4-6: Examination of Rubber Characteristics

The materials used are listed in Table 1. Test methods used for the mixtures and vulcanizates thereof were effected according to Table 2. The rubber mixtures were produced with a GK 1.5 E internal mixer from Harburg Freudenberger Maschinenbau GmbH.

TABLE 1
List of materials used in Examples 4-6

| | |
|---|---|
| S-SBR | BUNA ® VSL 4526-2, |
| | Ultrapolymers Deutschland |
| | GmbH |
| f-S-SBR-1 | SPRINTAN ™ SLR 4602- |
| | SCHKOPAU, TRINSEO ™ |
| f-S-SBR-2 | BUNA ® FX 3234A-2 HM, |
| | ARLANXEO © |
| BR | BUNA ® CB 24, Ultrapolymers |
| | Deutschland GmbH |
| Silica | ULTRASIL ® 7000 GR, Evonik |
| | Industries AG |
| Carbon black | CORAX ® N330, Gustav |
| | Grolmann GmbH & Co. KG |
| VP Si 263 silane | Evonik Resource Efficiency |
| | GmbH |
| ZnO | Zinkweiss Rotsiegel, Grillo |
| | Zinkoxid GmbH |
| Stearic acid | Edenor ST1, Caldic |
| | Deutschland GmbH |
| Oil | Vivatec 500, Hansen & |
| | Rosenthal KG |
| Wax | Protektor G 3108, Paramelt |
| | B.V. |
| 6PPD | Vulkanox ® 4020/LG, Rhein- |
| | Chemie GmbH |
| TMQ | Vulkanox ® HS/LG, Rhein- |
| | Chemie GmbH |
| DPG | Rhenogran ® DPG-80, Rhein- |
| | Chemie GmbH |
| CBS | Vulkacit ® CZ/EG-C, Rhein- |
| | Chemie GmbH |
| Sulfur | ground sulfur, Azelis S.A. |
| TBzTD | Richon TBzTD OP, Weber & |
| | Schaer GmbH & Co. KG |
| NR | SMR 10, Wurfbain Nordmann |
| | GmbH masticated at Harburg- |
| | Freudenberger Maschinenbau |
| | GmbH |

TABLE 2
List of physical test methods used in Examples 4-6

| Method | Standard |
|---|---|
| Rubber Process Analyzer (RPA) Strain Sweep | ASTM D7605 |
| Difference in shear modulus (G*): maximum shear | |
| modulus (MPa)—minimum shear modulus (MPa) | |
| Tensile strain on S1 test specimens at 23° C. | DIN 53 504 |
| Tensile strength (MPa) | |
| Modulus at 300% elongation (MPa) | |
| Strengthening factor: modulus at 300% elongation | |
| (MPa)/modulus at 100% elongation (MPa) | |
| Abrasion test (mm³) | DIN EN ISO 4649 |
| | ASTM D5963 |
| Dynamic/mechanical analysis at 60° C. | DIN 53513 |
| Dynamic complex modulus E* at 60° C. (MPa) | |

### Example 4: Solution Styrene-Butadiene Rubber/Butadiene Rubber Mixture (S-SBR/BR) with Silanes from Comparative Examples 1 and 2 and Examples 1-3

The mixture formulation is listed in Table 3.

TABLE 3
Mixture formulation of the S-SBR/BR mixture

| | Mixture 1 | Mixture 2 | Mixture 3 | Mixture 4 | Mixture 5 | Mixture 6 |
|---|---|---|---|---|---|---|
| | phr | phr | phr | phr | phr | phr |
| Substance | Comparison | Comparison | Inventive | Inventive | Inventive | Inventive |
| 1st stage | | | | | | |
| S-SBR | 96.3 | 96.3 | 96.3 | 96.3 | 96.3 | 96.3 |
| BR | 30 | 30 | 30 | 30 | 30 | 30 |
| Silica | 80 | 80 | 80 | 80 | 80 | 80 |
| Comparative | 7.12 | — | — | — | — | — |
| Example 1 | | | | | | |
| Comparative | — | 8.29 | — | — | — | — |
| Example 2 | | | | | | |
| Example 2 | — | — | 8.62 | — | — | 7.76 |
| Example 3 | — | — | — | — | 8.84 | — |
| VP Si 263 | — | — | — | — | — | 0.58 |
| Example 1 | — | — | — | 10.81 | — | — |
| Carbon | 5.0 | 5.0 | 5.0 | 5.0 | 5.0 | 5.0 |
| black | | | | | | |
| ZnO | 2.0 | 2.0 | 2.0 | 2.0 | 2.0 | 2.0 |
| Stearic acid | 2.0 | 2.0 | 2.0 | 2.0 | 2.0 | 2.0 |
| Oil | 8.75 | 8.75 | 8.75 | 8.75 | 8.75 | 8.75 |
| Wax | 2.0 | 2.0 | 2.0 | 2.0 | 2.0 | 2.0 |
| 6PPD | 2.0 | 2.0 | 2.0 | 2.0 | 2.0 | 2.0 |
| TMQ | 1.5 | 1.5 | 1.5 | 1.5 | 1.5 | 1.5 |
| 2nd stage | | | | | | |
| 1st stage | | | | | | |
| batch | | | | | | |
| DPG | 2.5 | 2.5 | 2.5 | 2.5 | 2.5 | 2.5 |
| 3rd stage | | | | | | |
| 2nd stage | | | | | | |
| batch | | | | | | |
| CBS | 1.6 | 1.6 | 1.6 | 1.6 | 1.6 | 1.6 |
| Sulfur | 2.0 | 2.0 | 2.0 | 2.0 | 2.0 | 2.0 |
| TBzTD | 0.2 | 0.2 | 0.2 | 0.2 | 0.2 | 0.2 |

The mixture production is described in Table 4.

TABLE 4
Mixture production of the S-SBR/BR mixture

| | |
|---|---|
| 1st stage | GK 1.5 E, feed temp. 70° C., 70 rpm, |
| | filling factor 0.65 |
| | Batch temp.: 145-155° C. |
| 0.0-0.5′ | Polymers |
| 0.5-1.0′ | TMQ, 6PPD |
| 1.0-2.0′ | 1/2 silica, silane(s), ZnO, stearic acid |
| 2.0-2.0′ | Vent, purge |
| 2.0-3.0′ | a) premix carbon black and oil and add together |
| | b) 1/2 silica |
| | c) remaining constituents from the first stage |
| 3.0-3.0′ | Purge |
| 3.0 - 5.0′ | Mix at 145-155° C., optionally varying speed |
| | Eject |
| | About 45 sec, on the roll (4 mm gap), eject sheet |
| Storage: 4-24 | |
| h/RT | |
| 2nd stage | GK 1.5 E, feed temp. 80° C., 80 rpm, |
| | filling factor 0.62 |
| | Batch temp.: 145-155° C. |
| 0.0-1.0′ | 1st stage batch |
| 1.0-3.0′ | DPG, mix at 145-155° C., optionally varying speed |
| 3.0-3.0′ | Eject |
| | About 45 sec, on the roll (4 mm gap), eject sheet |
| Storage: 4 - 24 | |
| h/RT | |
| 3rd stage | GK 1.5 E, feed temp. 50° C., 55 rpm, |
| | filling factor 0.59 |
| | Batch temp.: 90-110° C. |
| 0.0-2.0′ | 2nd stage batch, accelerator, sulfur |
| 2.0-2.0′ | Eject and process on the roll for about 20 sec, with |
| | gap 3-4 mm |
| Storage: | |

The results of physical tests on the rubber mixtures specified here and vulcanizates thereof are listed in Table 5. The vulcanizates were produced from the untreated mixtures from the third stage by heating at 165° C. for 14 min under 130 bar.

TABLE 5
Results of physical tests on the rubber mixtures and their vulcanizates

| | Mixture 1 | Mixture 2 | Mixture 3 | Mixture 4 | Mixture 5 | Mixture 6 |
|---|---|---|---|---|---|---|
| Method | Comparison | Comparison | Inventive | Inventive | Inventive | Inventive |
| Untreated | | | | | | |
| mixture | | | | | | |
| Δ modulus | 0.26 | 0.28 | 0.23 | 0.20 | 0.16 | 0.16 |
| (RPA)/MPa | | | | | | |
| Vulcanizate | | | | | | |
| DIN | 125 | 103 | 76 | 80 | 94 | 77 |
| abrasion/ | | | | | | |
| mm³ | | | | | | |

As apparent from Table 5, mixtures 3-6 comprising the inventive silanes, by comparison with comparative mixtures 1 and 2, have a lower difference in modulus in the RPA strain sweep, which indicates a reduced filler network. Moreover, the vulcanizates of these mixtures show a significant reduction in abrasion in the DIN test.

### Example 5: Functionalized Solution Styrene-Butadiene Rubber/Butadiene Rubber Mixture (f-S-SBR/BR) with Silanes from Comparative Examples 1 and 2 and Example 2

The mixture formulation is listed in Table 6.

TABLE 6
Mixture formulation of the f-S-SBR/BR mixture

| | Mixture 7 | Mixture 8 | Mixture 9 | Mixture 10 | Mixture 11 | Mixture 12 |
|---|---|---|---|---|---|---|
| | phr | phr | phr | phr | phr | phr |
| Substance | Comparison | Comparison | Inventive | Comparison | Comparison | Inventive |
| 1st stage | | | | | | |
| -S-SBR-1 | 70.0 | 70.0 | 70.0 | | | |
| f-S-SBR-2 | | | | 96.3 | 96.3 | 96.3 |
| BR | 30 | 30 | 30 | 30 | 30 | 30 |
| Silica | 80 | 80 | 80 | 80 | 80 | 80 |
| Comparative | 7.12 | — | — | 7.12 | — | — |
| Example 1 | | | | | | |
| Comparative | — | 8.29 | — | — | 8.29 | — |
| Example 2 | | | | | | |
| Example 2 | — | — | 8.62 | — | — | 8.62 |
| Carbon black | 5.0 | 5.0 | 5.0 | 5.0 | 5.0 | 5.0 |
| ZnO | 2.0 | 2.0 | 2.0 | 2.0 | 2.0 | 2.0 |
| Stearic acid | 2.0 | 2.0 | 2.0 | 2.0 | 2.0 | 2.0 |
| Oil | 35 | 35 | 35 | 8.75 | 8.75 | 8.75 |
| Wax | 2.0 | 2.0 | 2.0 | 2.0 | 2.0 | 2.0 |
| PPD | 2.0 | 2.0 | 2.0 | 2.0 | 2.0 | 2.0 |
| TMQ | 1.5 | 1.5 | 1.5 | 1.5 | 1.5 | 1.5 |
| 2nd stage | | | | | | |
| 1st stage | | | | | | |
| batch | | | | | | |
| DPG | 2.5 | 2.5 | 2.5 | 2.5 | 2.5 | 2.5 |
| 3rd stage | | | | | | |
| 2nd stage | | | | | | |
| batch | | | | | | |
| CBS | 1.6 | 1.6 | 1.6 | 1.6 | 1.6 | 1.6 |
| Sulfur | 2.0 | 2.0 | 2.0 | 2.0 | 2.0 | 2.0 |
| TBzTD | 0.2 | 0.2 | 0.2 | 0.2 | 0.2 | 0.2 |

The mixture production is described in Table 7 and Table 8.

TABLE 7
Mixture production of the f-S-SBR/BR mixture using f-S-SBR-1

| | |
|---|---|
| 1st stage | GK 1.5 E, feed temp. 70° C., 60 rpm, |
| | filling factor 0.67 |
| | Batch temp.: 140-155° C. |
| 0.0-0.5′ | Polymers |
| 0.5-1.0′ | TMQ, 6PPD |
| 1.0-2.0′ | 1/2 silica, 1/2 oil (premixed with a little silica), |
| | silane, ZnO, stearic acid |
| 2.0-2.0′ | Vent, purge |
| 2.0-3.0′ | a) premix carbon black and 1/2 oil and add |
| | together |
| | b) 1/2 silica |
| | c) remaining constituents from the first stage |
| 3.0-3.0′ | Purge |
| 3.0 - 5.0′ | Mix at 140-155° C., optionally varying speed |
| | Eject |
| | About 45 sec, on the roll (4 mm gap), eject sheet |
| Storage: 4-24 h/RT | |
| 2nd stage | GK 1.5 E, feed temp. 70° C., 70 rpm, |
| | filling factor 0.62 |
| | Batch temp.: 140-155° C. |
| 0.0-1.0′ | 1st stage batch |
| 1.0-3.0′ | DPG, mix at 140-155° C., optionally varying |
| | speed |
| 3.0-3.0′ | Eject |
| | About 45 sec, on the roll (4 mm gap), eject sheet |
| Storage: 4-24 h/RT | |
| 3rd stage | GK 1.5 E, feed temp. 50° C., 40 rpm, |
| | filling factor 0.58 |
| | Batch temp.: 90-110° C. |
| 0.0-2.0′ | 2nd stage batch, accelerator, sulfur |
| 2.0-2.0′ | Eject and process on the roll for about 20 sec, |
| | with gap 3-4 mm |
| Storage: 12 h/RT | |

TABLE 8
Mixture production of the f-S-SBR/BR mixture using f-S-SBR-2

| | |
|---|---|
| 1st stage | GK 1.5 E, feed temp. 70° C., 60 rpm, |
| | filling factor 0.67 |
| | Batch temp.: 140-155° C. |
| 0.0-0.5′ | Polymers |
| 0.5-1.0′ | TMQ, 6PPD |
| 1.0-2.0′ | 1/2 silica, silane, ZnO, stearic acid |
| 2.0-2.0′ | Vent, purge |
| 2.0-3.0′ | a) premix carbon black and oil and add together |
| | b) 1/2 silica |
| | c) remaining constituents from the first stage |
| 3.0-3.0′ | Purge |
| 3.0 - 5.0′ | Mix at 140-155° C., optionally varying speed |
| | Eject |
| | About 45 sec, on the roll (4 mm gap), eject sheet |
| Storage: 4-24 h/ | |
| RT | |
| 2nd stage | GK 1.5 E, feed temp. 70° C., 70 rpm, |
| | filling factor 0.62 |
| | Batch temp.: 140-155° C. |
| 0.0-1.0′ | 1st stage batch |
| 1.0-3.0′ | DPG, mix at 140-155° C., optionally varying |
| | speed |
| 3.0-3.0′ | Eject |
| | About 45 sec, on the roll (4 mm gap), eject sheet |
| Storage: 4-24 h/RT | |
| 3rd stage | GK 1.5 E, feed temp. 50° C., 40 rpm, |
| | filling factor 0.58 |
| | Batch temp.: 90-110° C. |
| 0.0-2.0′ | 2nd stage batch, accelerator, sulfur |
| 2.0-2.0′ | Eject and process on the roll for about 20 sec, |
| | with gap 3-4 mm |
| Storage: 12 h/ | |
| RT | |

The results of physical tests on the rubber mixtures specified here or vulcanizates thereof are listed in Table 9. The vulcanizates were produced from the untreated mixtures from the third stage by heating at 165° C. for 17 min under 130 bar.

TABLE 9
Results of physical tests on the vulcanizates

| | Mixture 7 | Mixture 8 | Mixture 9 | Mixture 10 | Mixture 11 | Mixture 12 |
|---|---|---|---|---|---|---|
| Method | Comparison | Comparison | Inventive | Comparison | Comparison | Inventive |
| Vulcanizate | | | | | | |
| DIN | 26 | 26 | 24 | 41 | 33 | 31 |
| abrasion, | | | | | | |
| 5N/mm³ | | | | | | |
| Dynamic | 6.1 | 6.7 | 7.2 | 6.9 | 7.1 | 8.7 |
| stiffness at | | | | | | |
| 60° C./MPa | | | | | | |

As apparent from Table 9, the vulcanizates of mixtures 9 and 12 comprising the silane according to the invention, compared to comparative mixtures 7 and 8 or 10 and 11, show an improvement in abrasion resistance according to DIN with simultaneously higher dynamic stiffness.

### Example 6: Natural Rubber Mixture (NR) Comprising Silanes from Comparative Examples 1 and 2 and Examples 1 and 2

The mixture formulation is listed in Table 10.

TABLE 10
Mixture formulation of the NR mixture

| | Mixture | Mixture | Mixture | Mixture | Mixture |
|---|---|---|---|---|---|
| | 13 phr | 14 phr | 15 phr | 16 phr | 17 phr |
| | Compar- | Compar- | Inven- | Inven- | Inven- |
| Substance | ison | ison | tive | tive | tive |
| 1st stage | | | | | |
| NR | 100 | 100 | 100 | 100 | 100 |
| Silica | 55 | 55 | 55 | 55 | 55 |
| Comparative | 6.14 | — | — | — | — |
| Example 1 | | | | | |
| Comparative | — | 7.14 | — | — | — |
| Example 2 | | | | | |
| Example 2 | — | — | 7.43 | — | 6.69 |
| VP Si 263 | — | — | — | — | 0.50 |
| Example 1 | — | — | — | 9.32 | — |
| ZnO | 3.0 | 3.0 | 3.0 | 3.0 | 3.0 |
| Stearic acid | 3.0 | 3.0 | 3.0 | 3.0 | 3.0 |
| Wax | 1.0 | 1.0 | 1.0 | 1.0 | 1.0 |
| PPD | 1.0 | 1.0 | 1.0 | 1.0 | 1.0 |
| TMQ | 1.0 | 1.0 | 1.0 | 1.0 | 1.0 |
| 2nd stage | | | | | |
| 1st stage batch | | | | | |
| 3rd stage | | | | | |
| 2nd stage batch | | | | | |
| CBS | 1.0 | 1.0 | 1.0 | 1.0 | 1.0 |
| Sulfur | 2.0 | 2.0 | 2.0 | 2.0 | 2.0 |
| DPG | 2.5 | 2.5 | 2.5 | 2.5 | 2.5 |

The mixture production is described in Table 11.

TABLE 11
Mixture production of the NR mixture

| | |
|---|---|
| 1st stage | GK 1.5 E, feed temp. 70° C., 70 rpm, |
| | filling factor 0.65 |
| | Batch temp.: 140-150° C. |
| 0.0-0.5′ | Polymers |
| 0.5 - 1.5′ | 1/2 silica, silane(s), ZnO, stearic acid |
| 1.5 -1.5′ | Vent and purge |
| 1.5 - 2.5′ | 1/2 silica, remaining constituents from the firs |
| | tstage |
| 2.5 - 2.3′ | Vent and purge |
| 2.5 - 4.0′ | Mix at 140-155° C., optionally varying speed |
| 4.0 - 4.0′ | Vent |
| 4.0 - 5.6′ | Mix at 140-155° C., optionally varying speed |
| | Eject |
| | About 45 sec, on the roll (4 mm gap), eject sheet |
| Storage: 24 h/ | |
| RT | |
| 2nd stage | GK 1.5 E, feed temp. 80° C., 80 rpm, |
| | filling factor 0.62 |
| | Batch temp.: 140-150° C. |
| 0.0-1.0′ | 1st stage batch |
| 1.0-3.0′ | Mix at 140-150° C., optionally varying speed |
| | Eject |
| | About 45 sec, on the roll (4 mm gap), eject sheet |
| Storage: 4-24 h/ | |
| RT | |
| 3rd stage | GK 1.5 E, feed temp. 50° C., 55 rpm, |
| | filling factor 0.59 |
| | Batch temp.: 90-110° C. |
| 0.0-2.0′ | 2nd stage batch, accelerator, sulfur |
| 2.0-2.0′ | Eject and process on the roll for about 20 sec, |
| | with gap 3-4 mm |
| Storage: 12 h/ | |
| RT | |

The results of physical tests on the rubber mixtures specified here or vulcanizates thereof are listed in Table 12. The vulcanizates were produced from the untreated mixtures by heating at 150+ C. for 17 min under 130 bar.

TABLE 12
Results of physical tests on the vulcanizates

| | Mixture | Mixture | Mixture | Mixture | Mixture |
|---|---|---|---|---|---|
| | 13 | 14 | 15 | 16 | 17 |
| | Compar- | Compar- | Inven- | Inven- | Inven- |
| Method | ison | ison | tive | tive | tive |
| Vulcanizate | | | | | |
| Tensile strength at | 23.6 | 23.1 | 26.3 | 24.5 | 25.1 |
| 23° C./MPa | | | | | |
| M300%/MPa | 6.2 | 7.9 | 9.2 | 8.4 | 9.0 |
| M300%/M100% | 3.9 | 4.0 | 4.4 | 4.4 | 4.5 |
| DIN abrasion/ | 159 | 152 | 110 | 136 | 138 |
| mm³ | | | | | |
| Dynamic stiffness | 6.7 | 6.8 | 7.4 | 7.0 | 7.2 |
| at 60° C./MPa | | | | | |

It is apparent from Table 12 that the vulcanizates of mixtures 15-17 comprising the silanes according to the invention have improved tensile strength, and an improved 300% modulus and strengthening factor (M300%/M100%). Furthermore, the mixtures show advantages in abrasion resistance according to DIN with simultaneously higher dynamic stiffness.

1. A thioether silane of formula I,
(R¹)ₓ(R²)₃₋ₓSi—R³—S—C(CH₂R⁴)_{y}(R⁵)_{3-y} (I),
wherein each R¹ is independently selected from the group consisting of a C1-C10-alkoxy group, a phenoxy group, a C4-C10-cycloalkoxy group, and an alkyl polyether group,
wherein the alkyl polyether group is —O—(R⁶—O)ᵣ—R⁷,
wherein each R⁶ is independently selected from the group consisting of a branched C 1-C30 hydrocarbon group, an unbranched C1-C30 hydrocarbon group, a saturated C1-C30 hydrocarbon group, an unsaturated C1-C30 hydrocarbon group, an aliphatic C1-C30 hydrocarbon group, an aromatic C1-C30 hydrocarbon group, and a mixed aliphatic/aromatic divalent Cl-C30 hydrocarbon group,
wherein r is an integer from 1 to 30,
wherein each R⁷ is independently selected from the group consisting of an unsubstituted group, a substituted group, a branched group, an unbranched group, a monovalent alkyl group, an alkenyl group, an aryl, and an aralkyl group,
wherein each R² is independently selected from the group consisting of a C6-C20-aryl group, a C1-C10-alkyl group, a C2-C20-alkenyl group, a C7-C20-aralkyl group, and a halogen,
wherein R³ is selected from the group consisting of a branched C 1-C30 hydrocarbon group, an unbranched C1-C30 hydrocarbon group, a saturated C1-C30 hydrocarbon group, an unsaturated C1-C30 hydrocarbon group, an aliphatic C1-C30 hydrocarbon group, an aromatic C1-C30 hydrocarbon group, and a mixed aliphatic/aromatic divalent C1-C30 hydrocarbon group,
wherein each R⁴ is independently selected from the group consisting of H, a branched C1-C30 hydrocarbon group, an unbranched C1-C30 hydrocarbon group, a saturated C1-C30 hydrocarbon group, an unsaturated C1-C30 hydrocarbon group, and an aliphatic C1-C30 hydrocarbon group,
wherein each R⁵ is independently selected from the group consisting of an unsubstituted C6-C20-aryl group, an alkyl-substituted C6-C20-aryl group, and a —C≡C—R⁸ group,
wherein each R⁸ is independently selected from the group consisting of H, an unsubstituted alkyl group, a substituted alkyl group, a branched alkyl group, an unbranched monovalent alkyl group, and a C6-C20-aryl group, and
wherein x=1, or 3, and y=1 or 2.

2. The thioether silane of claim 1, wherein each R⁵ is independently selected from the group consisting of an unsubstituted C6-C20-aryl group and an alkyl-substituted C6-C20-aryl group.

3. The thioether silane of claim 2, wherein R⁵ is phenyl.

4. The thioether silane of claim 3, wherein y=2.

5. A process for preparing the silane of claim 1, comprising reacting a silane of formula II,
(R¹)ₓ(R²)₃₋ₓSi—R³—SH (II),
with an alkene of formula III,
R⁴—HC═C(CH₂R⁴)_{y-1}(R⁵)_{3-y} (III).

6. The process of claim 5, AlCl₃ is used as catalyst in the reacting.

7. The process of claim 5, wherein R⁴ is H, and R⁵ is phenyl.

8. A rubber mixture, comprising at least one rubber and at least one thioether silane of claim 1.

9. The rubber mixture of claim 8, further comprising a mercaptosilane.

10. An item comprising the rubber mixture of claim 8, wherein the item is at least one selected from the group consisting of a pneumatic tyre, a tyre tread, a cable sheath, a hose, a drive belt, a conveyor belt, a roll covering, a tyre, a footwear sole, a gasket rings, and a damping element.
